(19) United States
(12) Patent Application Publication
(10) Pub. No.: US 2026/0117835 A1
(43) Pub. Date: Apr. 30, 2026

(54) REVERSE FORCE MECHANISM

(71) Applicant: Meidensha Corporation, Tokyo (JP)

(72) Inventors: Yuichi NISHIKIORI, Tokyo (JP); Takuya SHIMOKAWA, Tokyo (JP); Yoshiyuki TANIMIZU, Tokyo (JP); Toru TANIMIZU, Shizuoka (JP)

(73) Assignee: Meidensha Corporation, Tokyo (JP)

(21) Appl. No.: 19/164,599

(22) PCT Filed: Mar. 8, 2024
(86) PCT No.: PCT/JP2024/009056

§ 371 Date: Sep. 12, 2025

(30) Foreign Application Priority Data
Mar. 20, 2023 (JP) 2023-043851

(51) Int. Cl. F16F 3/04; H01H 33/40; H01H 33/42

(52) U.S. Cl. CPC F16F 3/04; H01H 33/40; H01H 33/42

(57) ABSTRACT

A reverse force mechanism includes a driver and a follower. The driver has a cam surface, and receives a positive operating force from a device in an axial direction, and moves in the axial direction. The follower includes a roller that applies a contact pressure to the cam surface. The cam surface is formed such that: a gradient angle varies in accordance with a variation in position of the driver, wherein the gradient angle is an angle between the axial direction of the positive operating force and a tangent to the cam surface and the roller at a point of contact between the cam surface and the roller; and the resultant operating force, which is a sum of the positive operating force and the reverse force, is substantially constant, wherein the reverse force is produced by the contact pressure, and varies in accordance with the gradient angle.

### TECHNICAL FIELD

The present invention relates to a reverse force mechanism that is combined with a device having a positive spring constant to cause a force acting in a certain direction on a certain point of application (henceforth simply referred to as a positive force), and has a negative spring constant to apply a force in a reverse direction (henceforth referred to as a reverse force) to the point of application, and thereby adjusts an operating force.

### BACKGROUND ART

A device having a positive force generates a restoring force in accordance with displacement thereof like a spring. A variable vacuum capacitor is an example of a device having a positive force. A variable vacuum capacitor includes a bellows inside, and varies an area where electrodes face each other while maintaining a vacuum section airtight, thereby varying the capacitance. When the capacitance varies, a restoring force and a vacuum pressure are applied, wherein the restoring force varies in accordance with the displacement depending on a spring constant of the bellows. Accordingly, the vacuum variable capacitor has a positive operating force characteristic in which a pull-in force is positive and minimized when in a most inserted position (a position where a movable electrode is closest to a fixed-side conductor), and increases as extraction progresses.

A patent document 1 discloses a conventionally known elastic mechanism for obtaining a reverse force, which is a reverse force mechanism to be combined with a device having a positive force. This conventional technique employs a combination of two mechanisms, namely, a positive elasticity mechanism having a positive spring constant, and a negative elasticity mechanism having a negative spring constant, wherein the negative elasticity mechanism is composed of two types of negative elasticity sections, namely, main and auxiliary negative elasticity sections. Such a configuration may be capable of obtaining an arbitrary positive or negative spring constant.

In order to operate a device, which has a positive operating force characteristic, at high speed and high accuracy, it is desirable to enable the device to be operated with a low and constant operating force. When it is desired to reduce the operating force or reduce variation in the operating force (for a constant operating force), and the device itself cannot be improved, it is required to combine the device with a reverse force mechanism. However, conventional reverse force mechanisms are large and complex in structure.

In view of the foregoing, it is an object to provide a simplified and downsized reverse force mechanism to further improve performance of a device having a positive force.

### PRIOR ART DOCUMENT(S)

### Patent Document(s)

Patent Document 1: Japanese Patent No. 6774102

### SUMMARY OF INVENTION The present invention has been made in view of the problems with the conventional technology described above.

According to one aspect of the present invention, a reverse force mechanism structured to be combined with a device that applies a positive force to a point of application, and adjust a resultant operating force by applying a reverse force to the point of application, the reverse force mechanism includes: a driver formed with a cam surface, and structured to receive a positive operating force from the device in an axial direction, and move in the axial direction; and a follower including a roller structured to be in contact with the cam surface and apply a contact pressure to the cam surface; wherein the cam surface is formed such that: a gradient angle varies in accordance with a variation in position of the driver, wherein the gradient angle is an angle between the axial direction of the positive operating force and a tangent to the cam surface and the roller at a point of contact between the cam surface and the roller; and the resultant operating force, which is a sum of the positive operating force and the reverse force, is substantially constant, wherein the reverse force is produced by the contact pressure, and varies in accordance with the gradient angle.

According to one aspect of the present invention, the reverse force mechanism is configured such that the follower includes: a rotation shaft structured to support the roller rotatably; a spring shaft fixed in a position facing the cam surface; and an adjuster spring arranged between the rotation shaft and the spring shaft, and structured to cause an elastic force to move the roller in a direction of expansion and contraction of the adjuster spring while maintaining the roller in contact with the cam surface, wherein the elastic force produces the contact pressure.

According to another aspect of the present invention, the reverse force mechanism is configured such that the follower includes: a main shaft fixed on a first side of the driver in the axial direction of the positive operating force; a spring shaft fixed on a second side of the driver in the axial direction of the positive operating force, wherein the second side is opposite to the first side; a link having a first end fixed to the main shaft; a rotation shaft attached to a second end of the link, wherein the second end is opposite to the first end; the roller rotatably supported by the rotation shaft; and an adjuster spring arranged between the rotation shaft and the spring shaft, and structured to cause an elastic force to move the roller along an arc centered on the main shaft while maintaining the roller in contact with the cam surface, wherein the elastic force produces the contact pressure that varies in accordance with the gradient angle and a link angle that is an angle between the spring shaft and the link; and the cam surface is formed such that the gradient angle and the link angle vary in accordance with a variation in position of the driver.

According to another aspect of the present invention, the reverse force mechanism is configured such that the cam surface is a cam surface groove structured to guide the roller; the follower includes: a main shaft fixed on a first side of the driver in a second axial direction that is perpendicular to the axial direction of the positive operating force on the gradient angle side; and a link having a first end connected to the main shaft; the roller attached to a second end of the link, wherein the second end is opposite to the first end; a spring shaft fixed on a second side of the driver in the second axial direction, wherein the second side is opposite to the first side; and an adjuster spring arranged between the roller and the spring shaft, and structured to cause an elastic force to move the roller along an arc centered on the main shaft with the roller guided by the cam surface groove, wherein the elastic force produces the contact pressure that varies in accordance with the gradient angle and a link angle that is an angle between the spring shaft and the link; and the cam surface groove is formed such that the gradient angle and the link angle vary in accordance with a variation in position of the driver.

According to one aspect of the present invention, the reverse force mechanism is configured such that the device is a variable vacuum capacitor; the driver is fixed to an operating rod of the variable vacuum capacitor; and the reverse force mechanism includes a portion directly fixed via a terminal conductor to a movable-side conductor of the variable vacuum capacitor in the axial direction of the positive operating force.

According to the present invention, it is possible to provide a simplified and downsized reverse force mechanism to further improve performance of a device having a positive force.

### BRIEF DESCRIPTION OF DRAWINGS

FIG. 1 is a schematic diagram illustrating principles of a reverse force mechanism according to a first embodiment.

FIG. 2 is a vector diagram illustrating the principles of the reverse force mechanism according to the first embodiment.

FIG. 3 is a schematic diagram illustrating principles of a reverse force mechanism according to a second embodiment.

FIG. 4 is a vector diagram illustrating the principles of the reverse force mechanism according to the second embodiment.

FIG. 5 is a front view of a combination of a reverse force mechanism and a variable vacuum capacitor according to a third embodiment.

FIG. 6 is a cross-sectional view of the reverse force mechanism taken along a line A-A′ in FIG. 5.

FIG. 7 is a cross-sectional view of the reverse force mechanism and the variable vacuum capacitor taken along a line B-B′ in FIG. 6.

FIG. 8 is a schematic diagram illustrating principles of the reverse force mechanism according to the third embodiment.

FIG. 9 is a vector diagram illustrating the principles of the reverse force mechanism according to the third embodiment.

### Mode(s) for Carrying Out Invention

In a cam mechanism, a component that moves another component is called a driver, and a component that is moved by movement of a driver, such as a roller, is called a follower. These components are collectively called a cam-roller mechanism. When a large force is applied to a follower, an operating force of a driver varies significantly.

It is noted that, when a large force is applied to a follower, an operating force of a driver is depleted (reduced). This force for depleting the operating force of the driver meets the definition of the term “reverse force” (a force that has a negative spring constant and acts in a reverse direction on a point of application on which the operating force of the driver acts).

According to the present invention, a reverse force mechanism serves to produce a low and constant resultant operating force by causing a roller of a follower, which is to suppress movement of a driver, to apply a greater controlled contact pressure to a curved cam surface of the driver than conventional mechanisms, and causing a gradient angle of the curved cam surface of the driver to vary in accordance with a position of the driver (a position of contact between the curved cam surface and the roller), and combining the positive operating force of the driver with the reverse force.

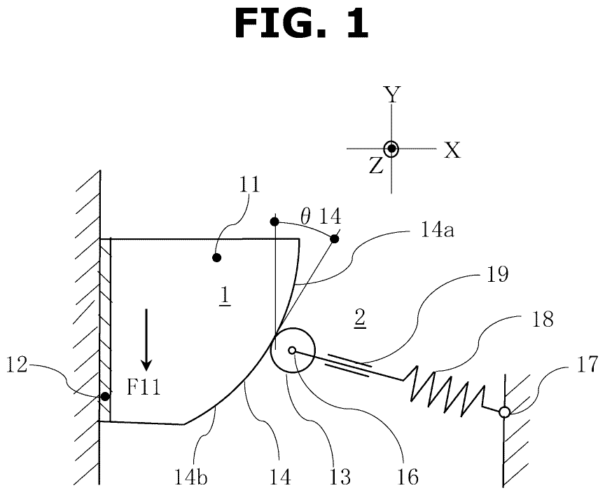

The following describes reverse force mechanisms according to first to third embodiments of the present invention in detail with reference to FIGS. 1 to 9.

[First Embodiment] In FIG. 1, a Y-axis represents an axial direction in which a positive operating force is applied, an X-axis represents an axial direction perpendicular to the Y-axis (an axial direction perpendicular to the Y-axis on a gradient angle side described below), and a Z-axis represents an axial direction perpendicular to the X-axis and the Y-axis.

As shown in FIG. 1, the reverse force mechanism according to the first embodiment is arranged between two walls opposed to each other in the X-axis direction. The reverse force mechanism according to the first embodiment, which is a cam-roller mechanism, includes a driver 1 and a linear motion follower 2.

The driver 1 includes a cam 11 in contact via a sliding member 12 with one of the walls facing in the X-axis direction. The cam 11 has a curved cam surface 14 formed thereon. A gradient angle 14 is defined as an angle between the direction of a positive operating force F11 and a tangent to the cam surface 14 and a roller 13 described below at a point of contact therebetween. The cam surface 14 is closest to being parallel to the Y-axis at its upper end in the Y-axis direction. The gradient angle 14 varies toward the lower side of the cam surface 14. Then, the cam surface 14 is closest to being parallel to the X-axis at its lower end in the Y-axis direction. The cam 11 receives input of the positive operating force F11 in the Y-axis direction from a device having a positive force, and accordingly moves in the Y-axis direction, sliding via the sliding member 12.

The linear motion follower 2 includes the roller 13, a rotation shaft 16, a spring shaft 17, an adjuster spring 18, and a sliding section 19.

The roller 13 is rotatably supported by the rotation shaft 16 and is in contact with the cam surface 14 of the cam 11. The spring shaft 17 is fixed to the second wall facing in the X-axis direction (the wall opposite to the wall on which the cam 11 is disposed). Namely, the spring shaft 17 is fixed at a position facing the cam surface 14. The adjuster spring 18 and the sliding section 19 are disposed between the rotation shaft 16 and the spring shaft 17. The adjuster spring 18 generates an elastic force. The sliding section 19 guides the roller 13 to move linearly (in a direction of expansion and contraction of the adjuster spring 18).

When the cam 11 moves up and down in the Y-axis direction, the elastic force of the adjuster spring 18 causes the roller 13 to move in the direction of expansion and contraction of the adjuster spring 18 while in contact with the cam surface 14. Simultaneously, a portion of the cam surface 14 in contact with the roller 13 varies within entirety of the cam surface 14. Accordingly, the roller 13 moves linearly (in the direction in which the adjuster spring 18 expands or contracts), so that the elastic force of the adjuster spring 18 varies. The elastic force produces a contact pressure at the point of contact between the roller 13 and the cam surface 14. Furthermore, the cam surface 14 is formed such that the gradient angle 14 varies in accordance with the position of the cam 11. The contact pressure produces a reverse force that varies depending on the gradient angle 14.

For an operating range of the cam 11 in the Y-axis direction, the gradient angle 14 of the cam surface 14 is set such that the resultant operating force of the positive operating force and the reverse force acting on the contact point between the cam surface 14 and the roller 13 is substantially constant.

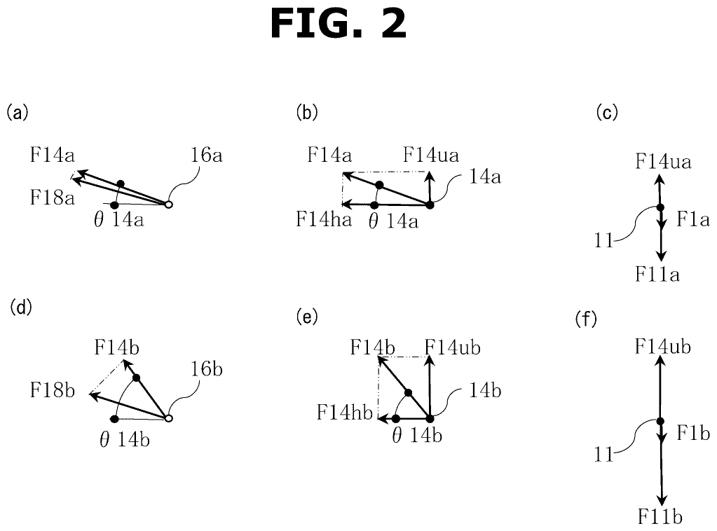

The following description refers to a vector diagram shown in FIG. 2.

A lower contact point 14a is defined as a point of contact between the cam surface 14 and the roller 13 when the cam 11 is positioned at its lowermost position in the operating range in the Y-axis direction. An upper contact point 14b is defined as a point of contact between the cam surface 14 and the roller 13 when the cam 11 is positioned at its uppermost position in the operating range in the Y-axis direction.

When the cam 11 is positioned at the lowermost position in the operating range in the Y-axis direction, the adjuster spring 18 is in a shortest state. Accordingly, the elastic force F18a is enlarged as shown in FIG. 2 (a). The angle between the vector of the elastic force F18a and the vector of the contact pressure F14a acting on the lower contact point 14a is small, so that the contact pressure F14a is substantially equal to the elastic force F18a and large as well.

Furthermore, when the cam 11 is positioned at the lowermost position in the operating range in the Y-axis direction, the gradient angle 14 is minimized (minimum gradient angle 14a). As shown in FIG. 2 (b), the contact pressure F14a is divided into a pressure F14ha in the X-axis direction and a reverse force F14ua in the Y-axis direction based on the minimum gradient angle 14a, wherein the reverse force F14ua is minimized.

As shown in FIG. 2 (c), when the cam 11 is positioned at the lowermost position in the operating range in the Y-axis direction, the positive operating force F11a is small. At the cam 11, the minimum reverse force F14ua and the small positive operating force F11a are combined to yield a resultant operating force F1a. The resultant operating force F1a is smaller than the positive operating force F11a.

When the cam 11 is positioned at the uppermost position in the operating range in the Y-axis direction, the adjuster spring 18 is in a longest state. Accordingly, the elastic force F18b is smaller than the elastic force 18a as shown in FIG. 2 (d). The angle between the vector of the elastic force F18b and the vector of the contact pressure F14b acting on the upper contact point 14b is large, so that the contact pressure F14b is smaller than the elastic force F18b.

Furthermore, when the cam 11 is positioned at the uppermost position in the operating range in the Y-axis direction, the gradient angle 14 is maximized (maximum gradient angle 14b). As shown in FIG. 2 (e), the contact pressure F14b is divided into a pressure F14hb in the X-axis direction and a reverse force F14ub in the Y-axis direction based on the maximum gradient angle 14b, wherein the reverse force F14ub is maximized.

As shown in FIG. 2 (f), when the cam 11 is positioned at the uppermost position in the operating range in the Y-axis direction, the positive operating force F11b is large. At the cam 11, the maximum reverse force F14ub and the large positive operating force F11b are combined to yield a resultant operating force F1b. The resultant operating force F1b is smaller than the positive operating force F11b. Furthermore, the resultant operating force F1a and the resultant operating force F1b are equal to each other. The resultant operating force F1 is thus substantially constant.

In the first embodiment, for each position of the cam 11 in the operating range, a corresponding reverse force (a force based on a negative spring constant and acting in the reverse direction on the same point of application) is produced. The gradient angle 14 is set to form the curved shape of the cam surface 14 such that the resultant operating force F1, which is the resultant force of the positive operating force F11 and the reverse force F14u, is substantially constant.

Specifically, the positive operating force F11 is minimized in the downward direction when the cam 11 is positioned at the lowermost position in its Y-axis operating range, and increases as the cam 11 moves upward in the Y axis direction, and is maximized in the downward direction when the cam 11 is positioned at the uppermost position in its Y-axis operating range. On the other hand, the reverse force F14u is minimized in the upward direction when the cam 11 is positioned at the lowermost position in its Y-axis operating range, and increases as the cam 11 moves upward in the Y-axis direction, and is maximized in the upward direction when the cam 11 is positioned at the uppermost position in its Y-axis operating range. As a result, the resultant operating force F1 is substantially constant.

According to the first embodiment, the reverse force mechanism is composed of the driver 1 and the linear motion follower 2, and can be simplified and made compact.

However, the magnitude of the elastic force F18 is limited by taking into account the contact pressure F14 (surface pressure) in relation to the mechanical life, depending on materials used and the shape of the roller 13.

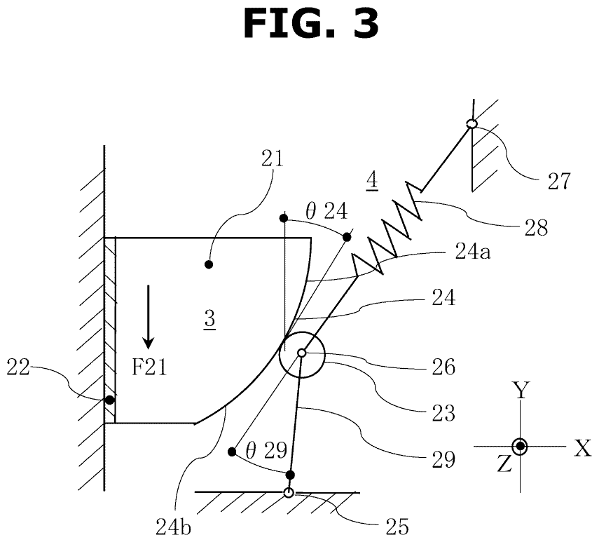

Furthermore, the gradient angle 14 is limited by taking into account that, if the gradient angle 14 is too large, the cam surface 14 and the roller 13 are brought beyond their operating limits and unable to return to their operating limits and normally operate. Furthermore, if the cam 11 is operated too fast, the linear motion follower 2 cannot follow the operation of the cam 11. In view of the foregoing, it is required to limit the control range from the lower contact 14a to the upper contact 14b, to limit the positive operating force F11 and the elastic force F18, and to limit the speed of operation.

[Second Embodiment] As shown in FIG. 3, the reverse force mechanism according to the second embodiment is arranged between a first wall facing in the X axis direction, a second wall facing in the X-axis direction, and a lower wall facing in the Y-axis direction. The reverse force mechanism according to the second embodiment, which is a cam-roller mechanism, includes a driver 3 and a swing follower 4.

The driver 3 includes a cam 21 in contact via a sliding member 22 with the first wall facing in the X-axis direction. The cam 21 has a curved cam surface 24 formed thereon. A gradient angle 24 is defined as an angle between the axial direction of a positive operating force F21 and a tangent to the cam surface 24 and a roller 23 described below at a point of contact therebetween. The cam surface 24 is closest to being parallel to the Y-axis at its upper end in the Y-axis direction. The gradient angle 24 varies toward the lower side of the cam surface 24. Then, the cam surface 24 is closest to being parallel to the X-axis at its lower end in the Y-axis direction. The cam 21 receives input of the positive operating force F21 in the Y-axis direction from a device having a positive force, and accordingly moves in the Y-axis direction, sliding via the sliding member 22.

The swing follower 4 includes the roller 23, a main shaft 25, a rotation shaft 26, a spring shaft 27, an adjuster spring 28, and a link 29.

The main shaft 25 is fixed to the lower wall facing in the Y-axis direction, and the spring shaft 27 is fixed to the second wall facing in the X-axis direction (the wall opposite to the wall where the cam 21 is disposed). The main shaft 25 is fixed below the driver 3 (the cam surface 24) in the Y-axis direction, and the spring shaft 27 is fixed above the driver 3 (the cam surface 24) in the Y-axis direction. The main shaft 25 is fixed to a first end of the link 29. The rotation shaft 26 is attached to a second end of the link 29, and swings (moves along an arc around the main shaft 25). The roller 23 is rotatably supported by the rotation shaft 26, and is in contact with the cam surface 24. The adjuster spring 28 is disposed between the rotation shaft 26 and the spring shaft 27. The adjuster spring 28 generates an elastic force. A link angle 29 is defined as an angle between the adjuster spring 28 and the link 29.

When the cam 21 moves up and down in the Y-axis direction, the elastic force of the adjuster spring 28 causes the roller 23 to move along an arc about the main shaft 25 while in contact with the cam surface 24. Simultaneously, a portion of the cam surface 24 in contact with the roller 23 varies within entirety of the cam surface 24. Accordingly, the roller 23 moves along an arc, so that the elastic force of the adjuster spring 28 varies. Furthermore, the cam surface 24 is formed such that the gradient angle 24 and the link angle 29 vary in accordance with the position of the cam 21. The elastic force produces a contact pressure at the point of contact between the roller 23 and the cam surface 24, wherein the contact pressure varies depending on the gradient angle 24 and the link angle 29. The contact pressure produces a reverse force that varies depending on the gradient angle 24.

For an operating range of the cam 21 in the Y-axis direction, the gradient angle 24 of the cam surface 24 and the link angle 29 are set such that the resultant operating force of the positive operating force F21 and the reverse force acting on the contact point between the cam surface 24 and the roller 23 is substantially constant.

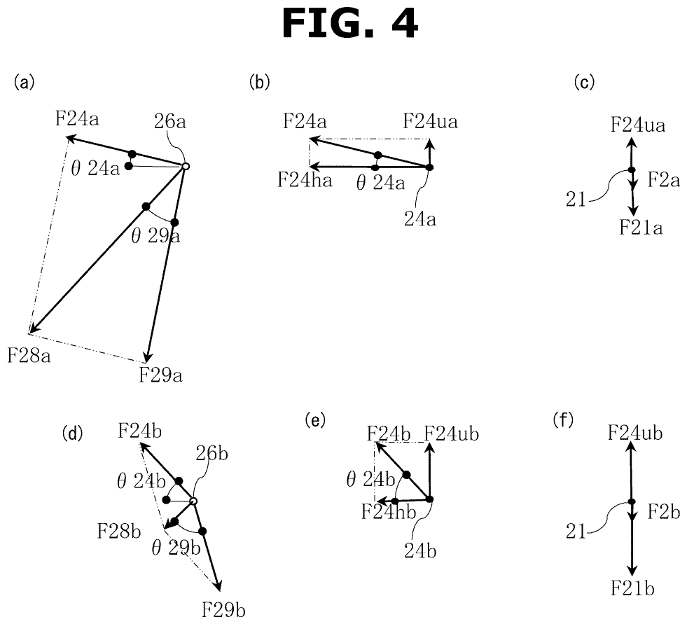

The following description refers to a vector diagram shown in FIG. 4.

A lower contact point 24a is defined as a point of contact between the cam surface 24 and the roller 23 when the cam 21 is positioned at its lowermost position in the operating range in the Y-axis direction. An upper contact point 24b is defined as a point of contact between the cam surface 24 and the roller 23 when the cam 21 is positioned at its uppermost position in the operating range in the Y-axis direction.

When the cam 21 is positioned at the lowermost position in the operating range in the Y-axis direction, the adjuster spring 28 is in a shortest state. Accordingly, the elastic force F28a is enlarged as shown in FIG. 4 (a). The elastic force F28a is divided into a force F29a on the link 29 and a contact pressure F24a based on the link angle 29a and the gradient angle 24a. Since the link angle 29a and the gradient angle 24a are small, the force F29a on the link 29 is large and the contact pressure F24a is small.

Furthermore, when the cam 21 is positioned at the lowermost position in the operating range in the Y-axis direction, the gradient angle 24 is minimized (minimum gradient angle 24a). As shown in FIG. 4 (b), the contact pressure F24a is divided into a pressure F24ha in the X-axis direction and a reverse force F24ua in the Y-axis direction based on the minimum gradient angle 24a, wherein the reverse force F24ua is minimized.

As shown in FIG. 4 (c), when the cam 21 is positioned at the lowermost position in the operating range in the Y-axis direction, the positive operating force F21a is small. At the cam 21, the minimum reverse force F24ua and the small positive operating force F21a are combined to yield a resultant operating force F2a. The resultant operating force F2a is smaller than the positive operating force F21a.

When the cam 21 is positioned at the uppermost position in the operating range in the Y-axis direction, the adjuster spring 28 is in a longest state. Accordingly, the elastic force F28b is smaller than the elastic force 28a as shown in FIG. 4 (d). The elastic force F28b is divided into a force F29b on the link 29 and a contact pressure F24b based on the link angle 29b and the gradient angle 24b. Since the link angle 29b and the gradient angle 24b are large, the force F29b on the link 29 is small and the contact pressure F24b is large.

Furthermore, when the cam 21 is positioned at the uppermost position in the operating range in the Y-axis direction, the gradient angle 24 is maximized (maximum gradient angle 24b). As shown in FIG. 4 (e), the contact pressure F24b is divided into a pressure F24hb in the X-axis direction and a reverse force F24ub in the Y-axis direction based on the maximum gradient angle 24b, wherein the reverse force F24ub is maximized.

As shown in FIG. 2 (f), when the cam 21 is positioned at the uppermost position in the operating range in the Y-axis direction, the positive operating force F21b is large. At the cam 21, the maximum reverse force F24ub and the large positive operating force F21b are combined to yield a resultant operating force F2b. The resultant operating force F2b is smaller than the positive operating force F21b. Furthermore, the resultant operating force F2a and the resultant operating force F2b are equal to each other. The resultant operating force F2 is thus substantially constant.

With the cam 21 in the operating range in the Y-axis direction, the elastic force F28 of the adjuster spring 28 varies significantly from the maximum to the minimum. However, the contact pressure F24 produced by the elastic force F28 varies little due to the link angle 29. Since the reverse force F24u resulting from the contact pressure F24 varies depending on the gradient angle 24, the range of variation of the gradient angle 24 of the cam surface 24 can be made small.

Since two parameters, the gradient angle 24 of the cam surface 24 and the link angle 29 of the link 29, are set, the resultant operating force F2 can be easily set substantially constant.

Specifically, the positive operating force F21 is minimized in the downward direction when the cam 21 is positioned at the lowermost position in its Y-axis operating range, and increases as the cam 21 moves upward in the Y axis direction, and is maximized in the downward direction when the cam 21 is positioned at the uppermost position in its Y-axis operating range. On the other hand, the reverse force F24u is minimized in the upward direction when the cam 21 is positioned at the lowermost position in its Y-axis operating range, and increases as the cam 21 moves upward in the Y-axis direction, and is maximized in the upward direction when the cam 21 is positioned at the uppermost position in its Y-axis operating range. As a result, the resultant operating force F2 is substantially constant.

As described above, the second embodiment produces advantageous effects similar to those of the first embodiment. Furthermore, it is possible to achieve a reduction in size in the X-axis direction.

In the configuration of the second embodiment, the roller 23 moves along an arc centered on the main shaft 25, wherein the contact pressure (surface pressure) F24 can be reduced, and the mechanical life can be extended. In other words, there is no need to limit the magnitude of the elastic force F28. The feature that the gradient angle 24 is set by taking into account two parameters, the curved cam surface 24 and the swing motion of the link 29, serves to make it easy to avoid the operating limitation of the gradient angle 24. As a result, the control range from the lower contact point 24a to the upper contact point 24b can be widened, and the application range of the positive operating force F21 and the elastic force F28 can be widened.

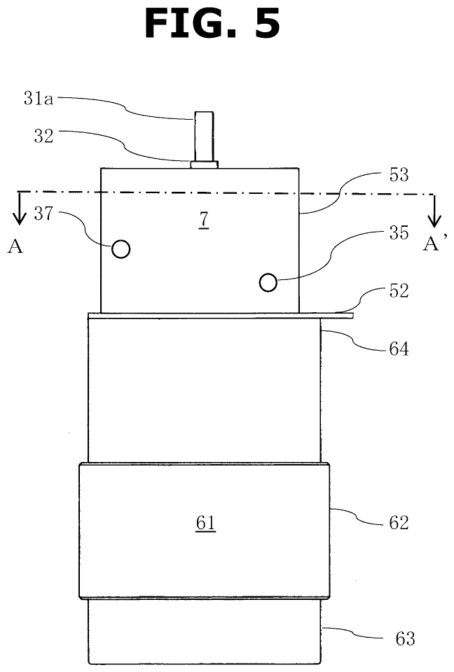

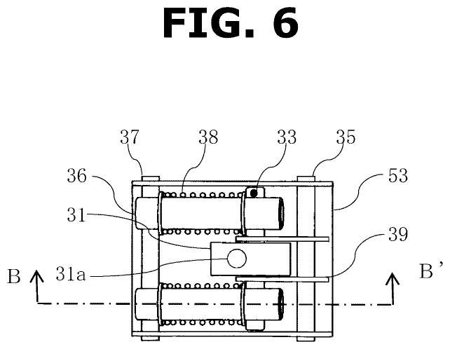

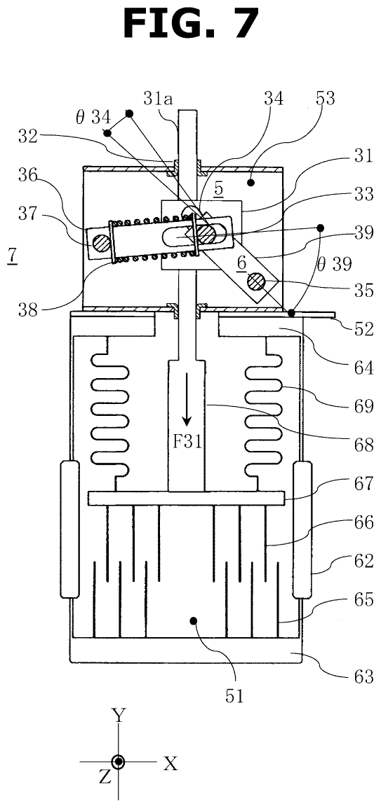

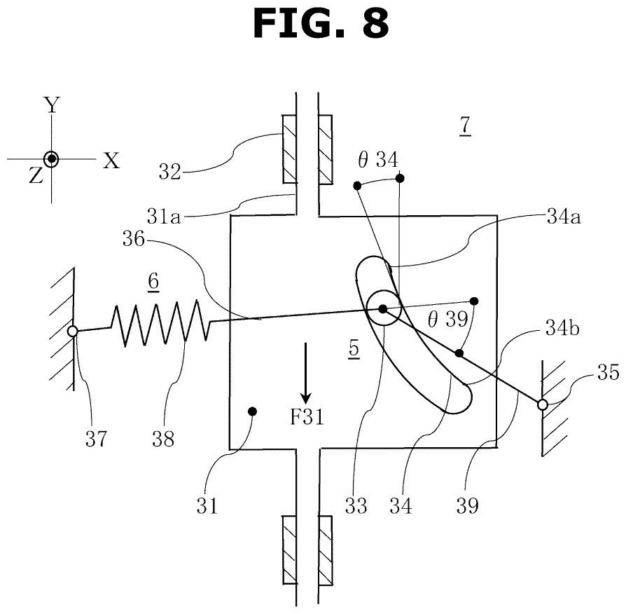

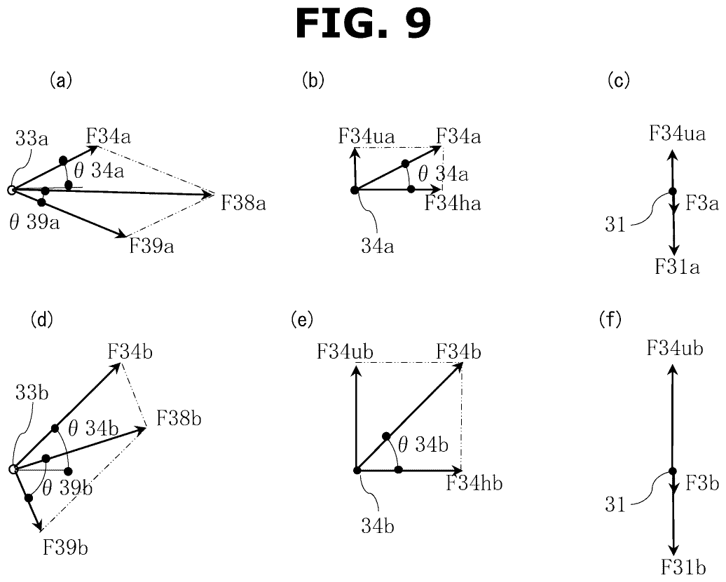

However, the provision of the spring shaft 27 fixed in the upper position in the Y-axis direction, results in an increase in Y-axis dimension of the reverse force mechanism, and requires a space in the Y-axis direction. Furthermore, if the cam 21 is operated too fast, the swing follower 4 cannot follow the operation of the cam 21.

[Third Embodiment] FIGS. 5 to 9 show a configuration in which a variable vacuum capacitor is combined with a reverse force mechanism 7 according to the third embodiment. FIG. 5 is a front view of a combination of the reverse force mechanism and the variable vacuum capacitor according to the third embodiment. FIG. 6 is a cross-sectional view of the reverse force mechanism taken along a line A-A′ in FIG. 5. FIG. 7 is a cross-sectional view of the reverse force mechanism and the variable vacuum capacitor taken along a line B-B′ in FIG. 6. FIG. 8 is a schematic diagram illustrating principles of the reverse force mechanism according to the third embodiment. FIG. 9 is a vector diagram illustrating the principles of the reverse force mechanism according to the third embodiment.

As shown in FIGS. 5 to 7, a variable vacuum capacitor 61 includes: a cylindrical body (e.g., a ceramic tube) 62 including at least a nonconductive part; a fixed-side conductor 63; and a movable-side conductor 64; wherein both ends of the cylindrical body 62 are closed by the fixed-side conductor 63 and the movable-side conductor 64 to form a vacuum vessel.

A reference numeral 65 denotes a fixed electrode disposed on an inside face of the fixed-side conductor 63 facing the vacuum vessel. The fixed electrode 65 is composed of a plurality of substantially cylindrical tubular electrode members having different inner diameters, wherein the electrode members are arranged with minute gaps therebetween.

A reference numeral 67 denotes a movable support part that supports a movable electrode 66 described below. The movable support part 67 is arranged to face the fixed-side conductor 63, and is structured to be moved in the Y-axis direction of the vacuum vessel (towards both ends of the cylindrical body 62) via a movable rod 68 described below. The movable support part 67 shown in FIG. 7 has a flat plate shape extending radially of the vacuum vessel.

Similar to the fixed electrode 75, the movable electrode 66 is composed of a plurality of substantially cylindrical tubular electrode members having different inner diameters, wherein the electrode members are arranged with minute gaps therebetween. Each electrode member of the movable electrode 66 is arranged on the fixed-side conductor 63 side of the movable support part 67 to face the fixed electrode 65 so that the electrode member can be inserted in and extracted from the fixed electrode 65 without contacting the fixed electrode 65 (inserted and extracted between electrode members of the fixed electrode 65, wherein the electrode members of the movable electrode 66 and the electrode members of the fixed electrode 65 cross each other), thereby forming electrostatic capacitance between the movable electrode 66 and the fixed electrode 65.

A reference numeral 68 denotes a movable rod that extends in the Y-axis direction from the backside of the movable support part 67 (from the movable-side conductor 64 side of the movable supporter part 67 where the movable electrode 66 is not arranged). In FIG. 7, the movable rod 68 is arranged to extend through the movable-side conductor 64 side of the vacuum vessel.

A reference numeral 69 denotes a bellows as a part of an electric current path of the variable vacuum capacitor 61, wherein the bellows 69 has a cylindrical shape (for example, a bellows-like shape), and is made of a flexible, thin, and soft metal. The bellows 69 is structured to allow the movable electrode 66, the movable support part 67, and the movable rod 68 to travel in the Y-axis direction, while holding a space (henceforth referred to as the vacuum chamber) 51 hermetic (so as to cause a vacuum state), wherein the space 51 is radially outside the bellows 69 within the vacuum vessel, i.e. is surrounded by the cylindrical body 62, the fixed-side conductor 63, the movable-side conductor 64, the movable support part 67, and the bellows 69. Radially inside the bellows 69 (on the movable rod 68 side of the bellows 69) within the vacuum vessel, a space under atmospheric pressure (henceforth referred to as atmospheric chamber) is formed.

In this way, the fixed electrode 65 and the movable electrode 66 are arranged within the vacuum section 51 with a minute gap therebetween. An operating rod 31a is extended from the movable rod 68. The operating rod 31a protrudes from the movable-side conductor 64. The movable electrode 76 is moved in the Y-axis direction by a drive source of the variable vacuum capacitor 61 via the operating rod 31a, the movable rod 78, and the movable support part 77, thereby making the capacitance variable.

When the movable rod 68 is inserted or extracted, a restoring force is caused by displacement due to a positive spring constant of the bellows 69, wherein a vacuum pressure is further applied. Accordingly, the variable vacuum capacitor 61 generates a positive operating force F31 that is a positive minimized pull-in force F31a when the movable rod 68 is inserted maximally, and a pull-in force increasing as the movable rod 68 is extracted, and is a maximized pull-in force F31b when the movable rod 68 is extracted maximally.

Furthermore, energization of the variable vacuum capacitor 61 causes a temperature increase such that the movable-side conductor 64 and a terminal conductor 52 reach their highest temperatures due to heat generated by the bellows 69, wherein the current carrying capacity depends on these temperatures.

A rectangular tube outer wall 53 of the reverse force mechanism 7 is directly fixed to the movable-side conductor 64 of the variable vacuum capacitor 61 in the Y-axis direction via the terminal conductor 52.

The positive operating force F31 in the Y-axis direction of the variable vacuum capacitor 61 is transmitted via the movable rod 68 and the operating rod 31a to a cam 31 (driver 5) in which a cam surface groove 34 is formed.

As shown in FIG. 8, the reverse force mechanism according to the third embodiment, which is a cam-roller mechanism, includes the driver 5 and a swing follower 6. The reverse force mechanism according to the third embodiment is arranged inside the rectangular tube outer wall 53. In the third embodiment, the cam surface groove is provided as a cam surface to guide the roller.

The driver 5 includes the cam 31 that moves up and down in the Y-axis direction, sliding via a sliding member 32. The cam 31 has the cam surface groove 34 formed therein. A gradient angle 34 is defined as an angle between the axial direction of the positive operating force F31 and a tangent to the cam surface groove 34 and the roller 33 described below at a point of contact therebetween. The cam surface groove 34 is closest to being parallel to the Y-axis at its upper end in the Y-axis direction. The gradient angle 34 varies toward the lower side of the cam surface groove 34. Then, the cam surface groove 34 is closest to being parallel to the X-axis at its lower end in the Y-axis direction. The cam 31 receives input of the positive operating force F31 from the variable vacuum capacitor 61 that is a device having a positive force.

The swing follower 6 includes the roller 33, a main shaft 35, a spring guide 36, a spring shaft 37, an adjuster spring 38, and a link 39.

The main shaft 35 is fixed to the rectangular tube outer wall 53 on a first side of the sliding member 32 (cam 31) in the X-axis direction. The spring shaft 37 is fixed to the rectangular tube outer wall 53 on a second side of the sliding member 32 (cam 31) in the X-axis direction. The main shaft 35 is connected to a first end of the link 39. The roller 33 is attached to a second end of the link 39, and swings (moves along an arc around the main shaft 35). The roller 33 is in contact with the cam surface groove 34. The spring guide 36 and the adjuster spring 38 are disposed between the roller 33 and the spring shaft 37. The adjuster spring 38 generates an elastic force. A link angle 39 is defined as an angle between the link 39 and the spring guide 36.

The positive operating force F31 in the Y-axis direction is transmitted to the cam 31 formed with the cam surface groove 34. The cam 31 moves up and down in the Y-axis direction, sliding via the sliding member 32. When the cam 31 moves up and down in the Y-axis direction, the elastic force of the adjuster spring 38 causes the roller 33 to move along an arc around the main shaft 35 while being guided by the cam surface groove 34. Simultaneously, a portion of the cam surface groove 34 in contact with the roller 33 varies. Accordingly, the roller 33 moves along an arc, so that the elastic force of the adjuster spring 38 varies. Furthermore, the cam surface groove 34 is formed such that the gradient angle 34 and the link angle 39 vary in accordance with the position of the cam 31. The elastic force produces a contact pressure at the point of contact between the roller 33 and the cam surface groove 34, wherein the contact pressure varies depending on the gradient angle 34 and the link angle 39. The contact pressure produces a reverse force that varies depending on the gradient angle 34.

For an operating range of the cam 31 in the Y-axis direction, the gradient angle 34 of the cam curved groove 34 and the link angle 39 are set such that the resultant operating force of the positive operating force F31 and the reverse force acting at the contact point between the cam curved groove 34 and the roller 33 is substantially constant.

The following description refers to a vector diagram shown in FIG. 9.

A lower contact point 34a is defined as a point of contact between the cam surface groove 34 and the roller 33 when the cam 31 is positioned at its lowermost position in the operating range in the Y-axis direction. An upper contact point 34b is defined as a point of contact between the cam surface groove 34 and the roller 33 when the cam 31 is positioned at its uppermost position in the operating range in the Y-axis direction.

When the cam 31 is positioned at the lowermost position in the operating range in the Y-axis direction, the adjuster spring 38 is in a shortest state. Accordingly, the elastic force F38a is enlarged as shown in FIG. 9 (a). The elastic force F38a is divided into a force F39a on the link 39 and a contact pressure F34a based on the link angle 39a and the gradient angle 34a. Since the link angle 39a and the gradient angle 34a are small, the force F39a on the link 39 is relatively large and the contact pressure F34a is small.

Furthermore, when the cam 31 is positioned at the lowermost position in the operating range in the Y-axis direction, the gradient angle 34a is minimized (minimum gradient angle 34a). As shown in FIG. 9 (b), the contact pressure F34a is divided into a pressure F34ha in the X-axis direction and a reverse force F34ua in the Y-axis direction based on the minimum gradient angle 34a, wherein the reverse force F34ua is minimized.

As shown in FIG. 9 (c), when the cam 31 is positioned at the lowermost position in the operating range in the Y-axis direction, the positive operating force F31a is small. At the cam 31, the minimum reverse force F34ua and the small positive operating force F31a are combined to yield a resultant operating force F3a. The resultant operating force F3a is smaller than the positive operating force F31a.

When the cam 31 is positioned at the uppermost position in the operating range in the Y-axis direction, the adjuster spring 38 is in a longest state. Accordingly, the elastic force F38b is smaller than the elastic force 38a as shown in FIG. 9 (d). The elastic force F38b is divided into a force F39b on the link 39 and a contact pressure F34b based on the link angle 39b and the gradient angle 34b. Since the link angle 39b and the gradient angle 34b are large, the force F39b on the link 39 is small and the contact pressure F34b is large.

Furthermore, when the cam 31 is positioned at the uppermost position in the operating range in the Y-axis direction, the gradient angle 34b is maximized (maximum gradient angle 34b). As shown in FIG. 9 (e), the contact pressure F34b is divided into a pressure F34hb in the X-axis direction and a reverse force F34ub in the Y-axis direction based on the maximum gradient angle 34b, wherein the reverse force F34ub is maximized.

When the cam 31 is positioned at the uppermost position in the operating range in the Y-axis direction, the positive operating force F31b is large. At the cam 31, the maximum reverse force F34ub and the large positive operating force F31b are combined to yield a resultant operating force F3b. The resultant operating force F3b is smaller than the positive operating force F31b. The resultant operating force F3a and the resultant operating force F3b are equal to each other. The resultant operating force F3 is thus substantially constant.

With the cam 31 in the operating range in the Y-axis direction, the elastic force F38 of the adjuster spring 38 varies significantly from the maximum to the minimum. However, the contact pressure F34 produced by the elastic force F38 varies little due to the link angle 39. Since the reverse force F34u resulting from the contact pressure F34 varies depending on the gradient angle 34, the range of variation of the gradient angle 34 of the cam surface groove 34 can be made small.

Since two parameters, the gradient angle 34 of the cam surface 34 and the link angle 39 of the link 39, are set, the resultant operating force F3 can be easily set substantially constant.

Specifically, the positive operating force F31 is minimized in the downward direction when the cam 31 is positioned at the lowermost position in its Y-axis operating range, and increases as the cam 31 moves upward in the Y axis direction, and is maximized in the downward direction when the cam 31 is positioned at the uppermost position in its Y-axis operating range. On the other hand, the reverse force F34u is minimized in the upward direction when the cam 31 is positioned at the lowermost position in its Y-axis operating range, and increases as the cam 31 moves upward in the Y-axis direction, and is maximized in the upward direction when the cam 31 is positioned at the uppermost position in its Y-axis operating range. As a result, the resultant operating force F3 is substantially constant.

As described above, the third embodiment produces advantageous effects similar to those of the second embodiment. Furthermore, it is possible to achieve a reduction in size in the Y-axis direction.

In the configuration of the third embodiment, the roller 33 moves along an arc centered on the main shaft 35, wherein the contact pressure (surface pressure) F34 can be reduced, and the mechanical life can be extended. In other words, there is no need to limit the magnitude of the elastic force F38. The feature that the gradient angle 34 is set by taking into account two parameters, the curved cam surface groove 34 and the swing motion of the link 39, serves to make it easy to avoid the operating limitation of the gradient angle 34.

Furthermore, the feature that the cam surface groove 34 guides the roller 33, serves to allow the swing follower 6 to follow movement of the cam 31 even when the cam 31 is quickly operated. As a result, the control range from the lower contact point 24a to the upper contact point 24b can be widened, and the application range of the positive operating force F31 and the elastic force F38 can be widened, and the provision of the cam surface groove 34 eliminates the need of any limitation on the operating speed.

However, the feature that the main shaft 35 and the spring shaft 37 are fixed to the left and right sides in the X-axis direction, results in an increase in X-axis dimension of the reverse force mechanism, and requires a space in the X-axis direction.

Furthermore, the feature that the reverse force mechanism 7 is directly fixed to the movable-side conductor 64 of the variable vacuum capacitor 61 in the Y-axis direction via the terminal conductor 52, serves to allow heat of the movable-side conductor 64 to flow via the terminal conductor 52 to the reverse force mechanism 7. This increases the heat dissipation area, increases the amount of heat dissipation, and decreases the temperature of the movable-side conductor 64. Since the current carrying capacity depends on the temperature, the current carrying performance of the variable vacuum capacitor 61 can be enhanced.

Although the present invention has been described in detail only for the specific embodiments, it is apparent to those skilled in the art that various modifications and variations are possible within the scope of the technical concept of the present invention, and it is natural that such modifications and variations fall within the scope of the patent claims.

[Other Embodiments] Although FIGS. 1 and 3 each show a cam mechanism on one side of the sliding section, multiple cam mechanisms may be arranged around the sliding section, wherein advantageous effects equivalent to those of the first and second embodiments can be obtained.

Regarding the cam shape, a linear motion cam type of a planar cam has been used as an example, but it may be replaced with another type such as a rotation cam type of a planar cam, an end face cam type of a three-dimensional cam, a cylindrical cam type, a conical cam type, or a drum cam type, which has a curved cam surface, wherein advantageous effects equivalent to those of the first to third embodiments can be obtained.

According to the present invention, when it is acceptable that the resultant operating force has a wide range of variation, the curved cam surface may be replaced with a straight and angled cam surface, wherein advantageous effects equivalent to those of the first to third embodiments can be obtained.

1. A reverse force mechanism structured to be combined with a device that applies a positive force to a point of application, and adjust a resultant operating force by applying a reverse force to the point of application, the reverse force mechanism comprising:
a driver formed with a cam surface, and structured to receive a positive operating force from the device in an axial direction, and move in the axial direction; and
a follower including a roller structured to be in contact with the cam surface and apply a contact pressure to the cam surface;
wherein the cam surface is formed such that:
a gradient angle varies in accordance with a variation in position of the driver, wherein the gradient angle is an angle between the axial direction of the positive operating force and a tangent to the cam surface and the roller at a point of contact between the cam surface and the roller; and
the resultant operating force, which is a sum of the positive operating force and the reverse force, is substantially constant, wherein the reverse force is produced by the contact pressure, and varies in accordance with the gradient angle.

2. The reverse force mechanism as claimed in claim 1, wherein the follower includes:
a rotation shaft structured to support the roller rotatably;
a spring shaft fixed in a position facing the cam surface; and
an adjuster spring arranged between the rotation shaft and the spring shaft, and structured to cause an elastic force to move the roller in a direction of expansion and contraction of the adjuster spring while maintaining the roller in contact with the cam surface, wherein the elastic force produces the contact pressure.

3. The reverse force mechanism as claimed in claim 1, wherein:
the follower includes:
a main shaft fixed on a first side of the driver in the axial direction of the positive operating force;
a spring shaft fixed on a second side of the driver in the axial direction of the positive operating force, wherein the second side is opposite to the first side;
a link having a first end fixed to the main shaft;
a rotation shaft attached to a second end of the link, wherein the second end is opposite to the first end;
the roller rotatably supported by the rotation shaft; and
an adjuster spring arranged between the rotation shaft and the spring shaft, and structured to cause an elastic force to move the roller along an arc centered on the main shaft while maintaining the roller in contact with the cam surface, wherein the elastic force produces the contact pressure that varies in accordance with the gradient angle and a link angle that is an angle between the adjuster spring and the link; and
the cam surface is formed such that the gradient angle and the link angle vary in accordance with a variation in position of the driver.

4. The reverse force mechanism as claimed in claim 1, wherein:
the cam surface is a cam surface groove structured to guide the roller;
the follower includes:
a main shaft fixed on a first side of the driver in a second axial direction that is perpendicular to the axial direction of the positive operating force on the gradient angle side; and
a link having a first end connected to the main shaft;
the roller attached to a second end of the link, wherein the second end is opposite to the first end;
a spring shaft fixed on a second side of the driver in the second axial direction, wherein the second side is opposite to the first side; and
an adjuster spring arranged between the roller and the spring shaft, and structured to cause an elastic force to move the roller along an arc centered on the main shaft with the roller guided by the cam surface groove, wherein the elastic force produces the contact pressure that varies in accordance with the gradient angle and a link angle that is an angle between the adjuster spring and the link; and
the cam surface groove is formed such that the gradient angle and the link angle vary in accordance with a variation in position of the driver.

5. The reverse force mechanism as claimed in claim 1, wherein:
the device is a variable vacuum capacitor;
the driver is fixed to an operating rod of the variable vacuum capacitor; and
the reverse force mechanism includes a portion directly fixed via a terminal conductor to a movable-side conductor of the variable vacuum capacitor in the axial direction of the positive operating force.
